(19) United States
(12) Patent Application Publication
(10) Pub. No.: US 2025/0367066 A1
(43) Pub. Date: Dec. 4, 2025

(54) Nutating Percussive Massage Gun

(71) Applicant: Charles Curley, Cortland, NY (US)

(72) Inventor: Charles Curley, Cortland, NY (US)

(21) Appl. No.: 19/298,506

(22) Filed: Aug. 13, 2025

Related U.S. Application Data
(63) Continuation-in-part of application No. 18/443,569, filed on Feb. 16, 2024, now Pat. No. 12,409,098.

(51) Int. Cl. A61H 23/00; A61H 15/00; A61H 23/02

(52) U.S. Cl. CPC A61H 23/006; A61H 15/0085; A61H 23/0254; A61H 2015/0042; A61H 2015/0064; A61H 2201/0153; A61H 2201/0188; A61H 2201/1215; A61H 2201/1673; A61H 2201/5005

(57) ABSTRACT

A handheld percussive massage gun having multiple orbiting spherical rollers for implementing combined massage actions of stretching and percussive massage upon a fascia surface. The rollers provide sequential percussive impacts at progressively distinct locations across the surfaces of a fascia region while also intermittently stretching the fascia at each of those multiple locations. In one embodiment, each spherical roller sequentially pulls the fascia away from an anchoring rest to stretch the fascia in multiple radial directions along the fascia surface while simultaneously providing multiple percussive impulses sequentially upon the fascia along an incrementally progressive path. All of the spherical rollers orbit about a single motor-driven axis.

### FIELD OF INVENTION

The invention herein is related to the fields of percussive and rolling massage devices that apply vibratory massage impulses to selected fascia and muscle groups of the human body. More particularly, the invention herein relates to those percussive massage devices that utilize motorized mechanisms that can be handheld while operated with one hand.

### COPENDING APPLICATION

Other various devices and methods of utilizing nutating motion for applying mechanized massage to the fascia regions of the human body have been disclosed in co-pending U.S. patent application Ser. No. 18/443,569 which was filed on Feb. 16, 2024 and is incorporated herein by reference in entirety.

### BACKGROUND

There exist many massage therapies and massage devices which have been designed to rehabilitate muscle fiber, stimulate the circulatory system or treat cellulite by rubbing, twisting, beating, stretching, compressing and rolling the upper superficial fatty layer and muscle layers that reside immediately underneath the human skin. One of the most common massage techniques used by massage therapists is formally called Tapotement, which is merely the rapid and repeated striking of the fascia. This technique is commonly known as “percussive massage” in laymen's terms.

While originally performed with the human hands of massage therapists, mechanized tools called “massage guns” or “fascia guns” have been historically developed with motors to simulate this type of massage therapy. Massage guns are handheld electromechanical devices which provide repeating mechanical impulses to one or more impulse heads that are pressed against specific target areas of the human body. In general, massage gun impulses are provided with motor-driven devices that move perpendicularly against the fascia surface or move rotationally against and along the fascia surface.

FIG. 1 is an excerpt from an early (1928) prior art massage gun patent disclosure that imposed repeated linear pulsations against the fascia by utilizing an electric motor. U.S. Pat. No. 1,657,765 disclosed a handheld massage gun having a handle 11 and an electric motor 18 that cyclically reciprocated the “percussor head” 42 while the device operator held the device in contact with the fascia surface. This device simulated the percussive action used by a massage therapist as illustrated in FIG. 2.

More recently, battery powered percussive massage guns have become commonly available. An example of a conventional prior art configuration is shown in FIG. 3. While the user holds the impulse head 905 against an area of the body, the motorized device causes a piston 906 to rapidly oscillate along axis 904 with various forces and frequencies which are adjustable by the user to impact the head 905 against a fascia surface. The contact surfaces utilized on massage gun heads are shaped like spheres, rollers, cups and forks, which are often provided as exchangeable attachments that snap into the vibrating end of the massage gun. Many such massage gun patents have been recorded which differ by the structure of the mechanism which produces the reciprocating piston motion.

Another type of percussive massage gun known historically in the art is distinguished by its orbital motion rather than linear motion. A prior art orbital massage gun was disclosed in U.S. Pat. No. 1,710,051 (1929) which is shown herein as FIG. 4A and FIG. 4B. The handheld device has a handle 13 and an electric motor 10 which rotates four shafts 21, each having a plurality of coincident disks 22. Each row of discs makes impulsive contact upon the fascia surface in a repeating sequence as the rows of discs 22 orbit about shaft 4. The disclosure explains;
In operation, having supplied current to the motor 10, the latter will rotate the disc bearing frame rapidly, permitting the successive transverse rows of disks, as they engage the flesh, to alternately press it and release it with a kneading action ('051 p 1 68-73)

FIG. 5 herein illustrates another prior art orbital percussive massage device which was described in patent publication US 2004/0133134 A1. That disclosure illustrates an orbital massage gun which utilizes six rows of wheels 30 which orbit about the axis of its handle. The handle also houses the device battery. The Abstract of that disclosure explains;
The wheels have a ridged circumference for rolling on the surface of the skin in a manner for stimulating the muscles and the circulatory system.

The orbital percussive massage devices have an advantage over the piston-driven massage devices in that the rollers can stretch the fascia along the plane of the fascia surface while at the same time imposing percussive forces. FIG. 6 demonstrates the compressive fascia bulge created by an orbiting roller 31 as it sweeps across the fascia 410. The fascia region in front of the roller is compressed while the fascia in the region trailing the roller is stretched along that axis of the roller's track in the orbiting direction. The stretching action simulates the massage technique which is known as myofascial release, which is the stretching action performed by a massage therapist as demonstrated in FIG. 7. Myofascial release helps to lengthen the fascia that covers the muscles and to move lymph fluid and fat through and along the fascia layers. The myofascial stretching along the plane of the fascia is said to treat cellulite, treat lymphedema (buildup of lymph fluid) and increase blood circulation. The invention herein combines the advantages of percussive massage and myofascial stretching. These combined massage actions are not available with conventional piston-type massage guns.

### SUMMARY OF THE INVENTION

The device being disclosed herein exploits the percussive action of a percussive massage gun while additionally providing stretching action along multiple percussive impact locations and directions. In one embodiment, six spherical rollers orbit upon a motorized spindle and produce radial stretching forces along the fascia surface in four radial directions from an anchoring rest which the user engages to moor the device to the fascia surface. FIG. 8 is a diagram which illustrates a “map” of the maximum penetration positions of the percussion rollers while viewing the fascia in the direction perpendicular to the fascia surface. The bullseyes each represent a position on the fascia surface that is struck by one of the percussion rollers in sequence. As each roller makes percussive contact upon the fascia surface, it simultaneously pulls (stretches) the fascia along the plane of the fascia away from the pressure point in the direction of the arrows. For example, the first roller strike intermittently stretches the fascia away from the pressure point along the direction S1. Each roller sequentially strikes the fascia along a path which induces the stretching directions to extend radially from the anchoring rest, thus stretching the fascia in repeating radial directions.

The sequence is achieved by suspending the spherical rollers such that they nutate in an orbit about the axis of the spindle upon which the rollers are supported. The resulting mechanism is much simpler than the reciprocating shaft mechanisms that incorporate pistons and pushrods of conventional percussive massage guns and is thus less costly to manufacture, while inducing more effective stimulation along multiple directions and locations across the fascia surface.

### BRIEF DESCRIPTION OF THE FIGURES

FIG. 1 is an illustration excerpted from a prior art massage gun patent.

FIG. 2 is an illustration depicting a prior art human massage technique known as Tapotement.

FIG. 3 is an illustration of a battery powered prior art massage gun.

FIG. 4A is an illustration excerpted from a prior art orbiting massage gun patent.

FIG. 4B is an illustration excerpted from the prior art orbiting massage gun patent of FIG. 4A.

FIG. 5 is an illustration excerpted from another prior art orbiting massage gun patent.

FIG. 6 is a diagram that explains the stretching affect induced by an orbiting roller.

FIG. 7 is an illustration depicting a prior art human massage technique known as Myofascial Release.

FIG. 8 is a diagram explaining the radial stretching vectors induced upon a fascia surface by the invention being described herein.

FIG. 9 is an isometric view of the device 100 being described herein.

FIG. 10 is a section view of the device 100.

FIG. 11 is a section view of the device 100 showing one percussion roller in contact with the fascia surface.

FIG. 12 is a section view of the device 100 showing two percussion rollers in contact with the fascia surface.

FIG. 13 is an isometric view of the motor-driven spindle mechanism of the device 100.

FIG. 14 is a side elevation view of the nutating roller array of the device 100.

FIG. 15, FIG. 16 and FIG. 17 are section views showing the contact positions of the nutating rollers in various sequential spindle positions.

FIG. 18 is a diagram explaining the striking positions and directions of the percussion rollers of device 100.

FIG. 19 is an isometric view of the device 200 which is an alternate embodiment of the device 100.

FIG. 20 is a section view of the device 200 showing one percussion roller and an anchoring rest in contact with the fascia surface.

FIG. 21 is a section view of the device 200 showing two percussion rollers and an anchoring rest in contact with the fascia surface.

FIG. 22 is an isometric view of the motor-driven spindle mechanism of device 200.

FIG. 23 is a side elevation view of the nutating roller array of device 200.

FIG. 24, FIG. 25 and FIG. 26 are section views showing the contact positions of the nutating rollers of device 200 in various sequential spindle positions.

FIG. 27 is a diagram explaining the striking positions and radial stretching directions of the percussion rollers of the device 200.

FIG. 28 is a table which explains the striking positions and stretching vectors of the percussion rollers of device 200 in detail.

FIG. 29 is an isometric view of the device 300 which is an alternate embodiment of the device 200.

FIG. 30 is an isometric view of the device 300 showing optional attachments.

FIG. 31 is an isometric view of the device 300 showing a non-orbiting roller attachment.

FIG. 32 is an isometric view of the device 400 which is an alternate embodiment of device 200.

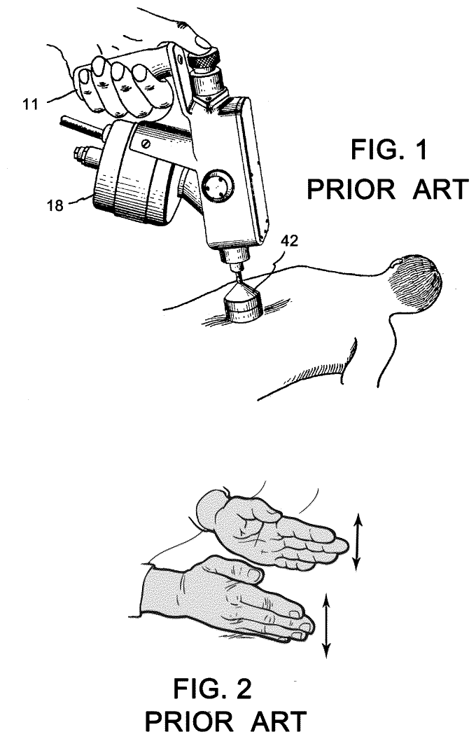

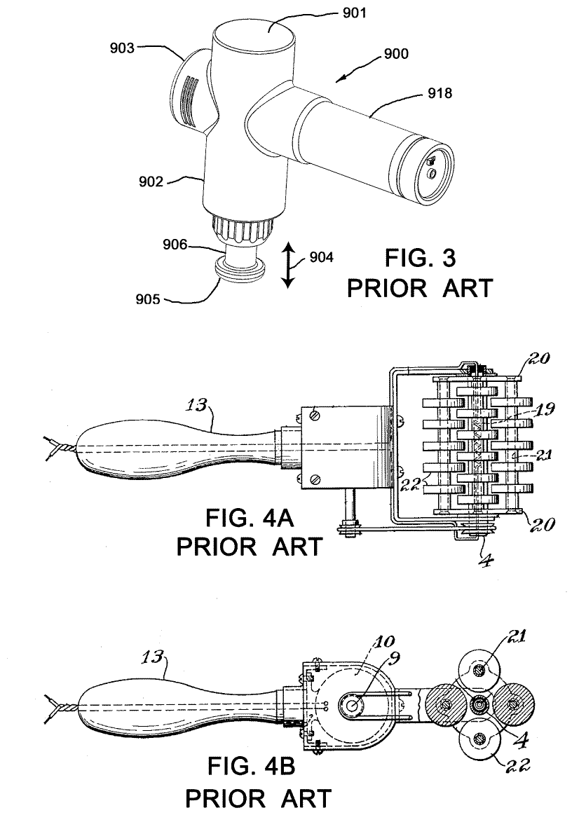

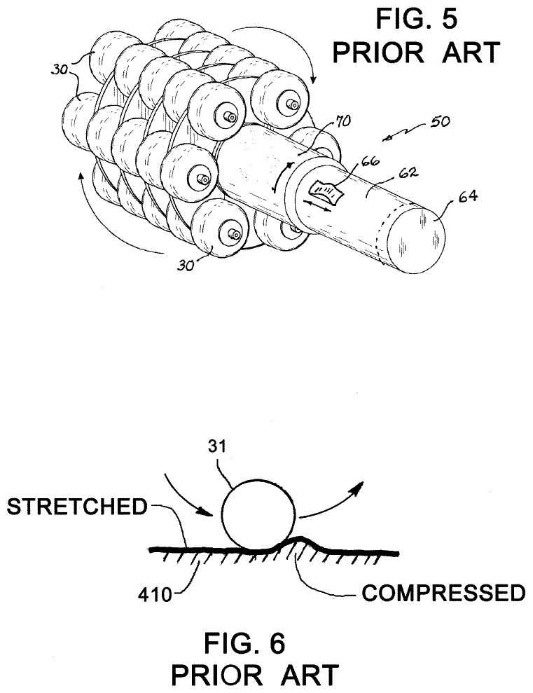

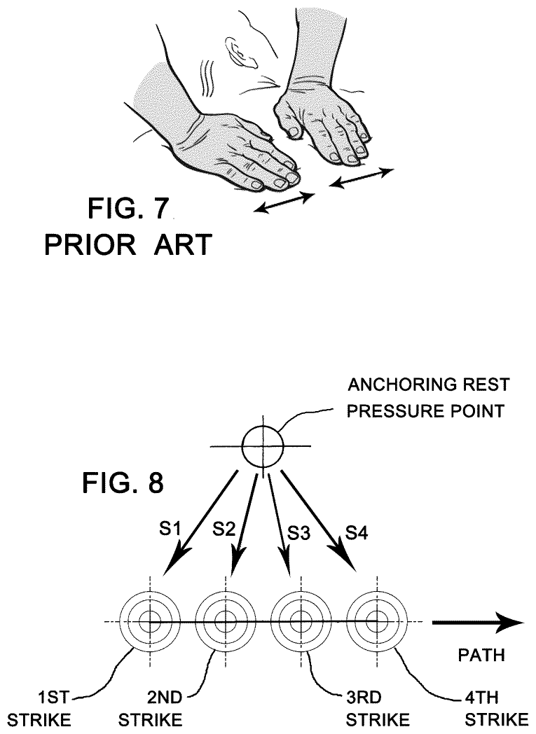

### DETAILED DESCRIPTION OF PREFERRED EMBODIMENTS

This disclosure frequently uses the words “nutating”, “nutation”, and “nutate” which may be perhaps obscure. The act of nutating refers to rocking, swaying or wobbling motion of a feature or features as they rotate about a common axis.

The term “orbiting roller” as used herein is defined as a roller which orbits about an axis that is noncoincident with that axis which defines the roller's own geometric center. An “orbiting roller” may rotate about its own centroidal axis while simultaneously rotating about another axis. Conversely, the term “non-orbiting roller” is defined as a roller that does not orbit about an axis other than its own centroidal center.

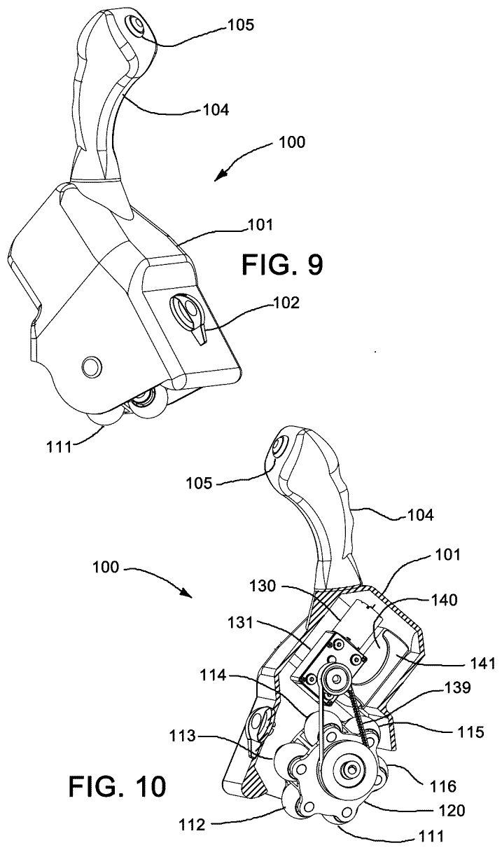

FIG. 9 and FIG. 10 illustrate an embodiment of the massage device disclosed herein which includes six spherical percussion rollers which each freely rotate upon their own axles while those axles orbit about the axis of a motor-driven spindle. FIG. 9 is a perspective view of the handheld device and FIG. 10 is a section view through the device casing. As the spindle rotates, each roller makes an individual percussive contact in sequence with the fascia surface while inducing repetitive percussive massage action. The device 100 consists of a casing body 101 which includes a handle portion 104, an operator-controlled activation switch 105 and a spindle 120 rotatable upon an axle within the housing. The six percussive rollers are labeled 111, 112, 113, 114, 115 and 116. The six rollers are each suspended upon their own axle within the spindle 120 which is rotationally driven by a battery-powered motor 130 and gearbox 131 via toothed belt 139.

The device includes a rechargeable battery pack 140 having a battery pack mount 141 which allows the batteries to be recharged through a charging port 144 (not shown). In one embodiment, the device has an operator control 102 for adjusting the speed of the motor. The operator may adjust the percussion frequency by controlling the motor speed.

In operation, the device operator grasps the joystick-like handle portion 104 with one hand and presses the rollers upon the fascia surface. While holding the device stationary over a target fascia region, the operator actuates the pushbutton switch 105 which energizes the motor to circulate the motor-driven spindle which supports the array of percussion rollers. The rollers orbit along a circular path at a constant angular velocity that is proportional to the angular velocity of the motor.

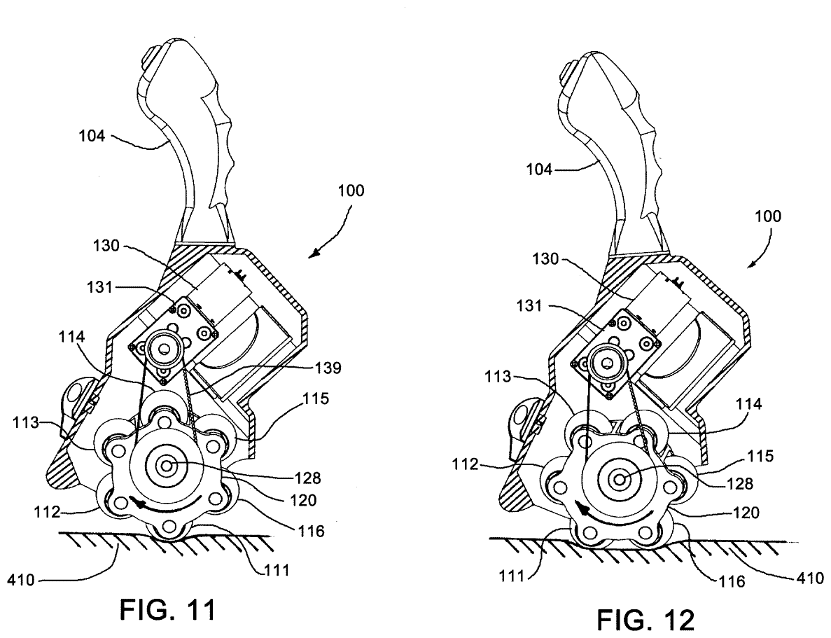

The section view of FIG. 11 shows that the entirety of the percussion rollers orbit synchronously about the axis 128 of the motor-driven spindle 120. Each roller makes a percussive impact upon the fascia region 410 in sequence as the spindle rotates. In FIG. 11, the spindle 120 is instantaneously located at a rotational position wherein roller 111 is in contact with the fascia surface 410 and located directly below axis 128 of the spindle 120 as the spindle rotates. This is the point within the spindle rotation cycle where the roller 111 has achieved its maximum penetration within the fascia surface. This maximum penetration position is described as the zenith position of roller 111. The fascia surface experiences six zenith positions during each revolution of the spindle 120 as each roller achieves maximum penetration. The operator's downward force may be exerted upon the fascia 410 solely through this one roller at this instantaneous position. As the spindle rotates further CW from the position shown in FIG. 11, roller 111 will eventually share the operator's downward force with roller 116 as shown in FIG. 12. As can be observed from the 6-roller geometry of this embodiment, the operator force will never be shared by more than two rollers. Thus, each roller passes through a temporary state of non-contact with the fascia region as the spindle rotates.

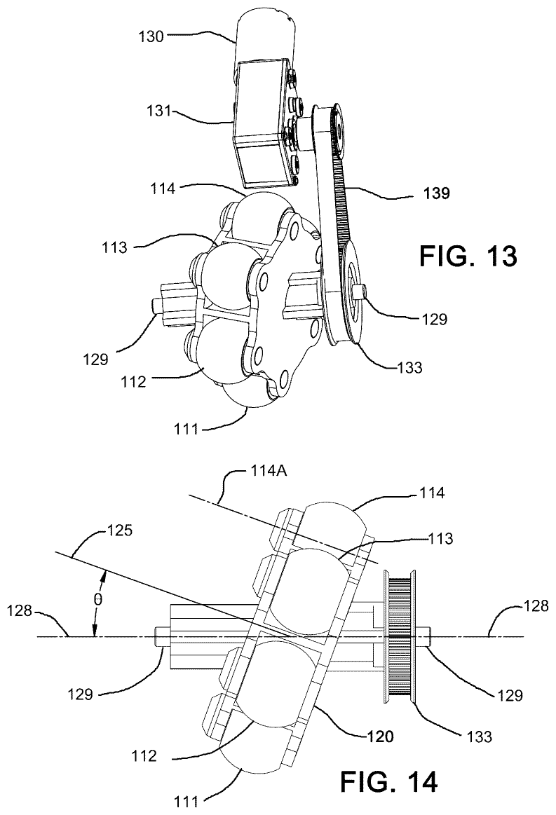

FIG. 13 is an isometric view of the motor-driven spindle and its drive when isolated from the device and FIG. 14 is an isolated view of the spindle 120 showing the relative angular articulation of the roller axes. The motor 130 is connected to a gearbox 131 for rotating an array of percussion rollers via belt 139. Referring to FIG. 14, the motor-driven spindle has an axle 129 which defines the axis of rotation 128 upon which spindle 120 rotates. Each roller freely rotates upon its own axle which is not coincident with the axle of any other roller. The axle of each roller is rigidly adjoined to the spindle 120 and each roller is mounted at an angle θ (theta) to the axis 128 of the spindle 120. The orbital array of rollers thus possesses its own centroidal axis 125 which defines the geometric center of the roller array.

In FIG. 14, the axis of the roller 114 is labeled 114A, and that axis is parallel to the rotation axis of all other rollers. Each roller possesses its own axis which is non-coincident with the spindle axis. The center of the roller array has an axis 125 from which the axis of all rollers are equidistant, thus forming a circular roller array. Each roller has an axis of rotation which is non-coincident with all other roller axes. All rollers orbit about the axis 125 as the spindle rotates about its axis 128. The spherical rollers thus form a circular array about the axis 128 which causes the rollers to orbit about the spindle axis 128 at an angle from the spindle axis. The roller axles are thus configured in a skewed circular array about the axis of the motor-driven spindle 120. The centroidal axis of the roller array 125 is angularly misaligned with the spindle axis 128 which causes the orbital array to synchronously nutate about the axis 128 of the motor-driven spindle as the spindle rotates about axis 128.

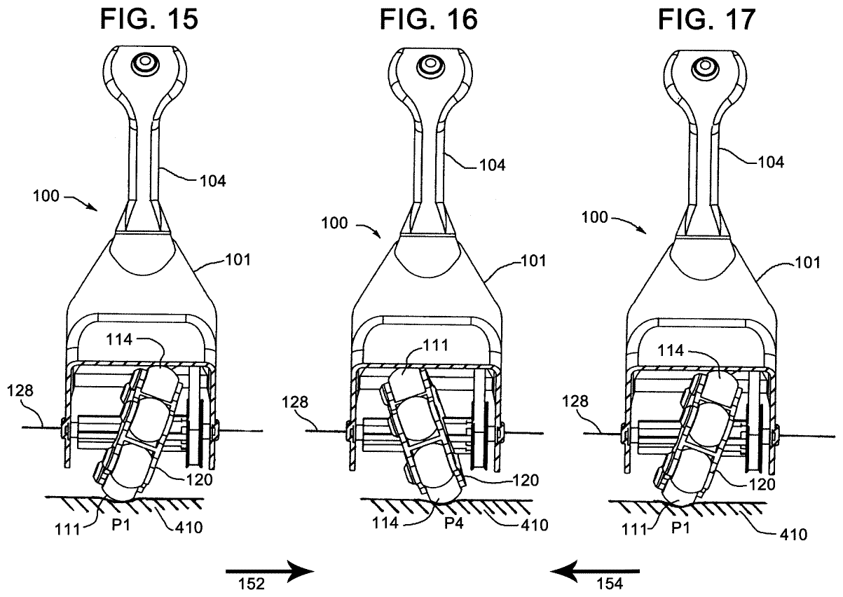

FIG. 15, FIG. 16 and FIG. 17 are section views which illustrate the device standing upright on a fascia surface 410 as the device would be oriented for operation by a user. A portion of the casing 101 has been sectioned off for the purpose of showing the spindle 120 at various rotational positions while looking perpendicular to the spindle shaft. FIG. 15 illustrates the position where roller 111 has achieved its zenith position, having impacted the fascia at a position on the fascia surface labeled P1. FIG. 16 illustrates the position of the spindle after one-half revolution from the position shown in FIG. 15. The roller 114 has achieved its zenith position in this view, having impacted the fascia at position P4. During the interim rotation between FIG. 15 and FIG. 16, rollers 112 and 113 strike the fascia at intermediate positions P2 and P3. Each roller strikes the fascia at a distinctly different position than its neighbor as the spindle rotates. Each impact incrementally migrates along the fascia surface in the direction of arrow 152 during the half revolution from FIG. 15 to FIG. 16.

FIG. 17 illustrates the spindle position whereupon the spindle has completed one revolution from the position shown in FIG. 15. While rotating from the position of FIG. 16 to the position of FIG. 17, the roller 111 has come back to strike the fascia at position P1. During that interim rotation, rollers 115 and 116 have struck the fascia at positions P5 and P6 which incrementally migrate in the direction of arrow 154. During one revolution, the fascia experiences a series of impacts which migrate incrementally from position P1 to position P4 and then reverse to position P1. The result is a series of percussive impacts that successively impact the fascia region along an incrementally progressive path in one direction and then reverse in the opposite direction during each spindle revolution. The extents of the percussion locations are herein described as the percussive path 144. The axis of the incrementally progressive path is parallel to the spindle axis.

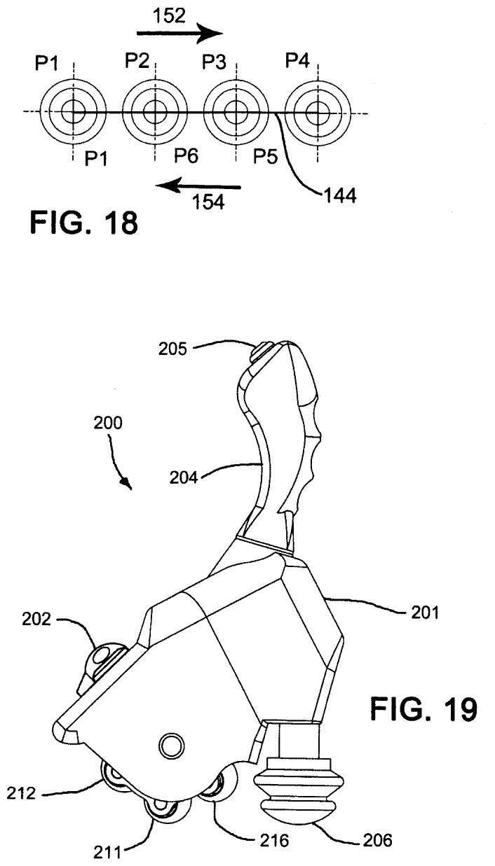

FIG. 18 is a diagram which represents the “map” of the percussive strikes and illustrates the zenith position of each of the six spherical rollers while looking in the direction perpendicular to the fascia surface during one revolution of the spindle 120. Each bullseye represents the relative location of each spherical roller impact as the spindle rotates, where the positions P1 to P6 represent the successive impact of rollers 111 to 116. The arrows 152 and 154 indicate the directions along which the impacts incrementally progress, as shown in FIG. 15 through FIG. 17. The solid line connecting the center of P1 with the center of P4 represents the extents of the percussive pathway 144.

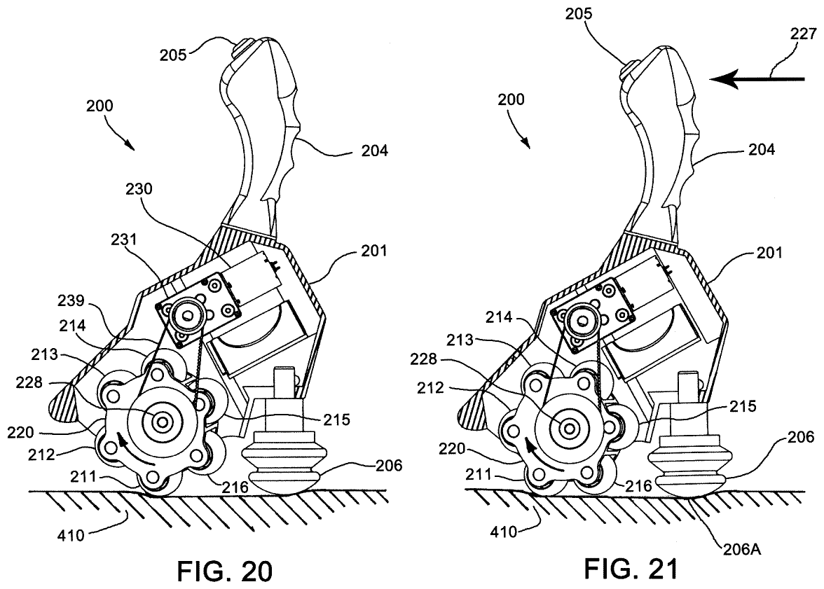

FIG. 19 illustrates an alternate embodiment 200 of the Nutating Percussive Massage Gun which utilizes an anchoring rest to enhance the stretching action of the orbiting percussion rollers. The device 200 consists of a casing body 201 which includes a handle portion 204, an actuation button 205 and an anchoring rest 206 located upon a distal end of the casing body 201. There exists six percussive rollers labeled 211, 212, 213, 214, 215 and 216 as shown in the section view of FIG. 20. The six rollers are each suspended upon their own axle within a spindle 220 which is rotationally driven by a unidirectional battery-powered motor 230 and gearbox 231 via toothed belt 239.

Referring to FIG. 20, the device includes a rechargeable battery pack 240 having a battery pack mount 241 which allows the batteries to be recharged through a charging port 244 (not shown). In one embodiment, the device has a speed control knob 202 with which the operator may adjust the percussion frequency by controlling the motor speed.

In operation, the device operator grasps the joystick-like handle portion 204 with one hand and presses the anchoring rest 206 upon the fascia surface. While holding the device stationary over a target fascia region, the operator actuates the pushbutton which energizes the motor to circulate the rollers in a direction away from the anchoring rest. The rollers orbit along a circular path at a constant angular velocity that is proportional to the angular velocity of the motor. The operator utilizes the handle 204 to provide a downward anchoring force on the anchoring rest 206 which is utilized to moor the device at a particular fascia region while the massage rollers orbit in a direction away from the anchoring rest to stretch the fascia within the region that is located between the roller impacts and the focusing rest.

The anchoring rest 206 is further utilized as a fulcrum by the operator to apply a variable amount of force at the interface between the percussive rollers and the fascia surface (the interface force) by rotating the device. In the embodiment shown in FIG. 20, the motor can only rotate in a CW direction for the purpose of stretching the fascia within the region between the anchoring rest and the percussion roller contact. The motor in embodiment 200 is only capable of unidirectional rotation.

In one embodiment, the anchoring rest 206 is composed of an elastomeric material which helps to grip the fascia, while the anchoring rest is composed of a hollow rubber semi-collapsible bellows in another embodiment. While planting the anchoring rest upon the fascia surface, the operator may rotate the handle 204 about the contact point 206A to vary the interface force by rotating the device in the direction of arrow 227 as shown in FIG. 21. The anchoring rest thus acts as a fulcrum for adjusting the penetration of the rollers. This natural geometric configuration facilitates operator adjustment of the percussive impacts while alleviating the need for electronic force adjustment and sensing mechanisms, thus minimizing manufacturing cost.

The section view of FIG. 20 shows that the entirety of the percussive rollers orbit about the axis 228 of the motor-driven spindle 220. In FIG. 20, the spindle 220 is instantaneously located at a rotational position wherein roller 211 is in contact with the fascia surface and located directly below axis 228 of the spindle 120 as the spindle rotates CW. This is the point within the spindle rotation cycle where the roller 211 has achieved its maximum penetration within the fascia surface. The operator's downward force may be exerted upon the fascia solely through the anchoring rest 206 and this one roller at this instantaneous position. As the spindle rotates further CW from the position shown in FIG. 20, roller 216 will eventually share the operator's force with roller 211 and the anchoring rest 206 as shown in FIG. 21. As can be observed from the 6-roller geometry of this embodiment, the operator force will never be shared by more than two rollers and the anchoring rest. Each roller passes through a temporary state of non-contact with the fascia region as the spindle rotates.

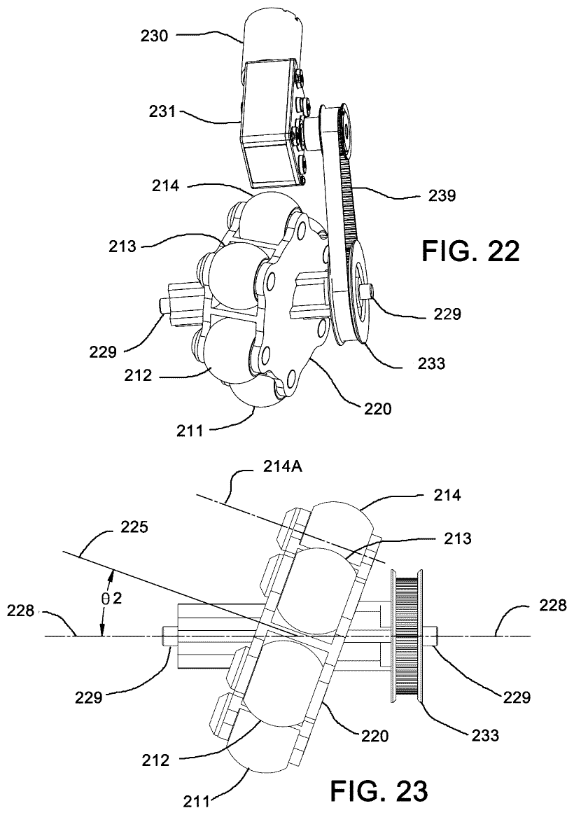

FIG. 22 is an isometric view of the motor-driven spindle and its drive when isolated from the device 200, and FIG. 23 is an isolated view of the spindle 220 showing the relative angular articulation of the roller axes. Referring to FIG. 23, the spindle has an axle 229 which defines an axis 228 upon which spindle 220 rotates. Each roller freely rotates upon its own axle which is not coincident with the axle of any other roller. The axle of each roller is rigidly adjoined to the spindle 220 and each mounted at an angle θ2 (theta-two) to the axis 228 of the spindle 220. The orbital array of rollers thus possesses its own centroidal axis 225 which defines the geometric center of the roller array. In FIG. 23, the axis of the roller 214 is labeled 214A, and that axis is parallel to the rotation axis of all other rollers.

The center of the roller array has an axis 225 from which the axis of all rollers are equidistant, thus forming a circular roller array. All rollers orbit about the axis 225 as the spindle rotates about its axis 228. The spherical rollers thus form a circular array about the axis 228 which causes the rollers to orbit about the spindle axis 228 at an angle from the spindle axis. The rollers are thus configured in an orbital array about the axis of the motor-driven spindle 228. The axis of the roller array 225 is angularly misaligned with the spindle axis 228 which causes the orbital array to synchronously nutate about the axis 228 of the motor-driven spindle as the spindle rotates about axis 228.

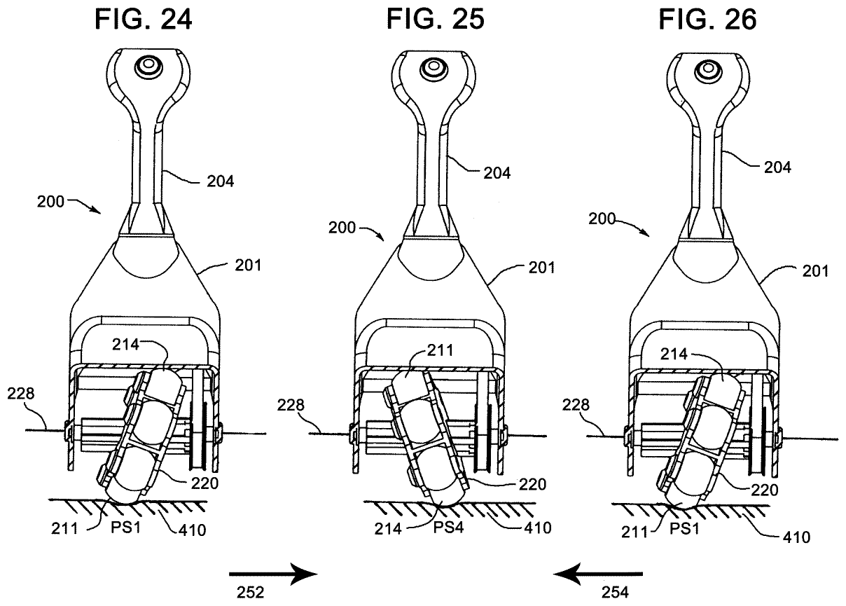

FIG. 24, FIG. 25 and FIG. 26 are section views which illustrate the device standing upright on a fascia surface with the anchoring rest pressed upon the fascia surface as the device would be oriented for operation by a user. A portion of the casing has been sectioned off for the purpose of showing the spindle at various rotational positions while looking perpendicular to the spindle shaft. FIG. 24 illustrates the position where roller 211 has achieved its zenith position, having impacted the fascia at a position on the fascia surface labeled PS1. FIG. 25 illustrates the position of the spindle after one-half revolution from the position shown in FIG. 24. The roller 214 has achieved its zenith position in this view, having impacted the fascia at position PS4. During the interim rotation between FIG. 24 and FIG. 25, rollers 212 and 213 strike the fascia at intermediate positions PS2 and PS3. Each roller strikes the fascia at a distinctly different position than its neighbor as the spindle rotates. Each percussive impact incrementally migrates along the fascia surface in the direction of arrow 252 during the half revolution from FIG. 24 to FIG. 25.

FIG. 26 illustrates the spindle position whereupon the spindle has completed one revolution from the position shown in FIG. 24. While rotating from the position of FIG. 25 to the position of FIG. 26, the roller 211 has come back to strike the fascia at position PS1. During that interim rotation, rollers 215 and 216 have struck the fascia at positions PS5 and PS6 which incrementally migrate in the direction of arrow 254. During one revolution, the fascia experiences a series of impacts which migrate incrementally from position PS1 to position PS4 and then reverse to position PS1. The result is a series of percussive impacts that successively migrate along a linear path in one direction and then reverse in the opposite direction during each spindle revolution. The extents of the percussion locations are herein described as the percussive path 244. The axis of the percussive path is parallel to the spindle axis.

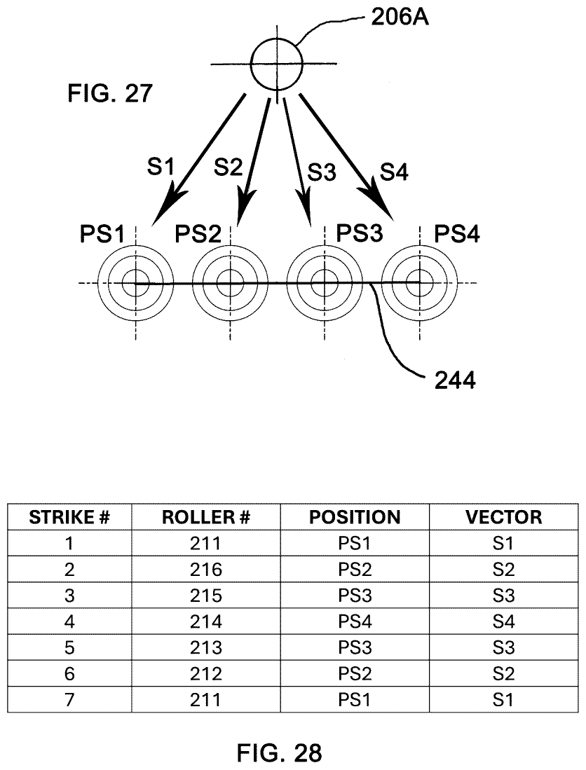

The anchoring rest restrains the fascia surface from moving within the local vicinity of the percussive impacts. Each percussive impact intermittently stretches the fascia along the fascia surface in a direction away from the anchoring rest, which is geometrically located at the approximate center of the percussive pathway 244. The result is an intermittent stretching of the fascia in a radial direction away from the anchoring rest focal center 206A as each percussion roller sweeps through the fascia surface 410. The sequential impulses induce intermittent stretching of the fascia within the fascia region in multiple radial directions from the anchoring rest as the spindle 220 rotates. FIG. 27 is a diagram which represents the “map” of the percussive strikes and the radial directions of the intermittent stretching when looking directly downward upon the fascia surface. The arrows indicate the directions (vectors) along which the intermittent stretching force is induced along the fascia surface during each percussive contact.

Referring to FIG. 27, the first spherical roller 211 impacts the fascia surface at position PS1 and intermittently stretches the fascia along the radial direction S1 from the anchoring rest whose focal point is 206A. Likewise, the second spherical roller 212 next impacts the fascia surface at position PS2 and intermittently stretches the fascia along the radial direction S2 from the anchoring rest. Each spherical roller impacts the fascia at a distinctly different location, thus inducing a different radial stretching vector from the focal point 206A of the anchoring rest center. The table in FIG. 28 summarizes the radial directions associated with each spherical roller when referring to the diagram of FIG. 27. Reference to FIG. 20 is additionally helpful when referring to this table.

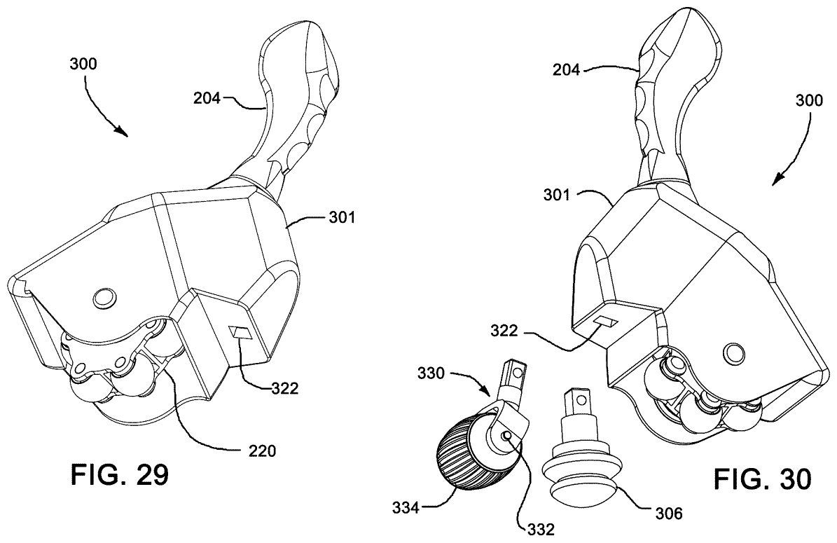

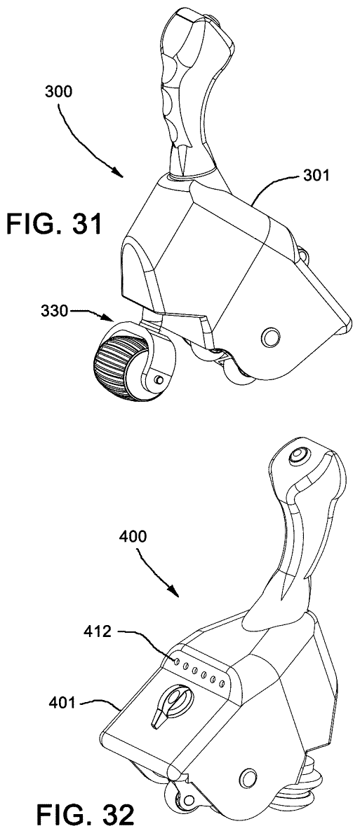

A further alternate embodiment allows the device to be utilized for imposing percussive massage in a traversing mode by exchanging an attachment. The device 300 as illustrated in FIG. 29 possesses a socket 322 in its casing 301 for attaching and detaching various accessories to the massage gun 300. Other than the casing 301, the components of the device 300 are identical to the components of device 200. One accessory is a hollow rubber hemispherical shape 306 having a bellows and the same shape as the anchoring rest 206 which was previously shown in FIG. 19. The anchoring rest 306 is an attachment which is receivable within a socket in the device housing. Component 306 can be snapped into and out of the socket 322 of the device 300 which is shown in FIG. 30. Alternately, device 300 may receive an attachment 330 comprising a freely rotatable non-orbiting roller. Attachment 330 can be snapped into the socket 322, where the attachment 330 possesses a non-orbiting roller 334 for bearing upon the facia surface which freely rotates upon an axle 332. After engaging the attachment 330, the device 300 may be traversed along various fascia regions along a limb or torso for the combined stretching and percussion treatment of the fascia surfaces within those regions as shown in FIG. 31.

The motor rotates unidirectionally to circulate the spherical rollers away from the anchoring rest 206 for stretching the fascia in the embodiment of FIG. 20. In the embodiment of FIG. 10, the motor rotates bidirectionally to provide additional massage effects. In one variant of the device 100, the device operator may utilize a switch on the device housing to control the direction of the spindle rotation. In another embodiment, the device may possess a controller that periodically changes the spindle rotation direction absent an intervention of the operator.

The orbiting rollers may be composed of a rigid material or an elastomeric material. In some embodiments, rigid rollers are used to more aggressively induce forces upon the fascia. Elastomeric rollers are used to provide less aggressive but more comfortable stimulating affect.

The orbiting rollers are freely rotatable about their own central axis in some embodiments, having axles that are rigidly attached to their spindles. In another embodiment which induces more aggressive forces upon the fascia, the orbiting rollers are not freely rotatable upon their own axles and are instead fixedly adjoined to their spindles and unable to rotate about their roller centroid. In yet another embodiment, the rollers are rotatable upon their axles with retardation such that they induce mild friction upon the fascia as they rotate. The retardation may be induced by utilizing an axial wave washer aligned with the roller axis which provides a frictional thrust force.

In another embodiment, an enhanced affect is achieved with synchronous illumination of LED's. The progressive movement of the spherical roller penetration is visualized for the operator by providing an array of LED's which are each briefly illuminated in a rhythm which is synchronized with the sequential percussive impacts of each massage roller when the spindle rotates.

FIG. 32 illustrates such an embodiment labeled device 400 wherein an LED array is arranged in a columnar array 412 on a rear surface of the massage gun casing. The mechanical components of the device 400 are identical to those of the device 200 with the exception of the casing 401. Six LED's are embedded in a surface of the casing 401. Each of the six LED's is temporarily illuminated in a sequence that corresponds in time to the zenith penetration position of each roller as the percussions migrate along the percussion path, first in one direction and then in reverse. In alternate embodiments, the LED array is added to the casing of device 100, device 200 and device 300.

The handheld massage device is small, light in weight, simple to operate, easily controllable with one hand and therefore especially useful for self-massage in the gym or at home. Its multiple applications include muscular stretching and toning, cellulite treatment, and circulation system stimulation improvement when treating upper and lower limbs. In comparison to conventional massage guns, the Nutating Percussive Massage Gun provides sweeping massage forces along multiple radial surface directions while providing percussive forces at multiple locations over a wider treatment region.

Variations of these embodiments may be apparent to one of ordinary skill. Other numbers of percussive rollers, other roller shapes and other numbers or roller-supporting spindles could be utilized without deviating from the scope of the invention. Other types of motors and other types of power transmission devices could also be utilized. Variations in spindle velocity and/or direction could also be employed to create non-uniform impulse effects. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A handheld, self-powered massage device for applying percussive massage to a fascia region, the device comprising:
a casing including a handle portion;
a battery;
a motor located within the casing for rotating an array of percussion rollers;
an operator controlled activation switch;
a motor-driven spindle for supporting the array of percussion rollers;
the motor-driven spindle having an axis of rotation;
each roller possessing its own axis which is non-coincident with the spindle axis;
each roller axis being non-coincident with all other roller axes;
the axis of each roller oriented to the motor-driven spindle at an angle from the spindle axis;
the roller axes configured in an orbital array, the orbital array having its own centroidal axis;
the centroidal axis of the orbital array angularly misaligned with the spindle axis;
the misaligned axis causing the orbital array to synchronously nutate about the spindle axle as the spindle continuously rotates;
each roller making a percussive impulse with the fascia region in sequence as the spindle rotates;
each roller passing through a temporary state of non-contact with the fascia region as the spindle rotates;
the entirety of the device's percussion rollers orbiting synchronously about a single motor-driven axis; and
the sequential percussions contacting the fascia region along an incrementally progressive path that is parallel to the spindle axle.

2. The massage device of claim 1 wherein the orbiting rollers are freely rotatable upon their own centroidal axis.

3. The massage device of claim 1 wherein the orbiting rollers are not freely rotatable upon their own centroidal axis.

4. The massage device of claim 1 having an operator control for adjusting a speed of the motor.

5. The massage device of claim 1 wherein the rollers are composed of an elastomeric material.

6. The massage device of claim 1 wherein the rollers are composed of a rigid material.

7. A handheld, self-powered massage device for applying percussive massage to a fascia region, the device comprising:
a casing including a handle portion;
a battery;
a motor located within the casing for rotating an array of percussion rollers;
an operator controlled activation switch;
an anchoring rest for mooring the device;
a motor-driven spindle for supporting the array of percussion rollers;
the motor-driven spindle having an axis of rotation;
each roller possessing its own axis which is non-coincident with the spindle axis;
each roller axis being non-coincident with all other roller axes;
the axis of each roller oriented to the motor-driven spindle at an angle from the spindle axis;
the roller axes configured in an orbital array, the orbital array having its own centroidal axis;
the centroidal axis of the orbital array angularly misaligned with the spindle axis;
the misaligned axis causing the roller array to synchronously nutate about the spindle axle as the spindle continuously rotates;
each roller making a percussive impulse with the fascia region in sequence as the spindle rotates;
each roller passing through a temporary state of non-contact with the fascia region as the spindle rotates;
the entirety of the device's percussion rollers orbiting synchronously about a single motor-driven axis;
the sequential impulses contacting the fascia region along a migrating path that is parallel to the spindle axle; and
the sequential percussions inducing intermittent stretching of the fascia within the fascia region in multiple radial directions from the anchoring rest as the spindle rotates.

8. The massage device of claim 7 wherein the orbiting rollers are freely rotatable upon their own central axis.

9. The massage device of claim 7 wherein the orbiting rollers are not freely rotatable upon their own central axis.

10. The massage device of claim 7 having an operator control for adjusting a speed of the motor.

11. The massage device of claim 7 wherein the rollers are composed of an elastomeric material.

12. The massage device of claim 7 wherein the rollers are composed of a rigid material.

13. The massage device of claim 7, whereupon the anchoring rest is an attachment which is receivable within a socket in the device housing.

14. The massage device of claim 13 wherein the socket may receive an attachment comprising a freely rotatable non-orbiting roller.

15. The massage device of claim 14 wherein the device is traversable along a surface of the fascia region.

16. The massage device of claim 1 having an array of LED's which are each briefly illuminated in a rhythm which is synchronized with the sequential percussive impacts of each massage roller when the spindle rotates.

17. The massage device of claim 7 having an array of LED's which are each briefly illuminated in a rhythm which is synchronized with the sequential percussive impacts of each massage roller when the spindle rotates.

18. The massage device of claim 1 wherein the motor is unidirectional.

19. The massage device of claim 1 wherein the motor is bidirectional.
